(19) United States
(12) Patent Application Publication
(10) Pub. No.: US 2025/0137312 A1
(43) Pub. Date: May 1, 2025

(54) METHOD FOR DETERMINING A DOOR OPENING REQUEST, SENSOR FACILITY FOR THIS PURPOSE AND HOUSEHOLD APPLIANCE

(71) Applicant: BSH Hausgeräte GmbH, München (DE)

(72) Inventors: Simon MAYER, Dornstadt (DE); Peter HELLWIG, Dischingen (DE); Matthias HAGMAYER, Dischingen (DE)

(21) Appl. No.: 18/894,043

(22) Filed: Sep. 24, 2024

(30) Foreign Application Priority Data
Oct. 31, 2023 (DE) 102023210768.6
Apr. 16, 2024 (DE) 102024110654.9

(51) Int. Cl. E05F 15/616; F25D 23/02

(52) U.S. Cl. CPC E05F 15/616; F25D 23/028; E05Y 2400/44; E05Y 2900/31

(57) ABSTRACT

A method determines a door opening request based on a pressure actuation against a door of a household appliance. A plunger is driven by an electric machine via a transmission. An electrical voltage is applied to a stator winding which is electrically coupled to a control unit at least during temporary support of the plunger head against a door inner face. When the door is in the closed state a force is applied to the plunger and by a sensor facility a stator winding-side induced voltage is detected, which has a voltage pulse depending on the pressure actuation. An amplitude of the voltage pulse is compared in a first comparison with a voltage comparison value and a temporal extent of the voltage pulse is compared in a second comparison with a time comparison value. The door opening request is determined depending on comparison results of the first and second comparison.

### CROSS-REFERENCE TO RELATED APPLICATION

This application claims the priority, under 35 U.S.C. § 119, of German Patent Applications DE 10 2023 210 768.6, filed Oct. 31, 2023, and DE 10 2024 110 654.9, filed Apr. 16, 2024; the prior application is herewith incorporated by reference in its entirety.

### FIELD AND BACKGROUND OF THE INVENTION

The invention relates to a method for determining a door opening request based on a pressure actuation of a user against an outer face of a door of a household appliance. The opening of the door is effected by means of a plunger that is arranged so as to move in the direction of a longitudinal axis. The longitudinal axis of the plunger is orientated in a transverse manner with respect to a door inner face when the door is in the closed state and the plunger has on the door side a first plunger end with a plunger head. The plunger is driven by means of a rotating electric machine which has a rotor that is arranged so as to be able to rotate with respect to a stator, for which purpose the rotor and the plunger are mechanically coupled in terms of drive technology by means of a transmission. An electrical voltage is applied to a stator winding of the stator which is electrically coupled to a control unit so as to cause the door to open at least during temporary support of the plunger head against the door inner face. Moreover, the invention relates to a sensor facility for determining a door opening request based on a pressure actuation of a user against an outer face of a door of a household appliance. The opening of the door is effected by means of a plunger that is arranged so as to move in the direction of a longitudinal axis. The longitudinal axis of the plunger is orientated in a transverse manner with respect to a door inner face when the door is in the closed state and the plunger has on the door side a first plunger end with a plunger head. The plunger can be driven by means of a rotating electric machine which has a rotor that is arranged so as to be able to rotate with respect to a stator, for which purpose the rotor and the plunger are mechanically coupled in terms of drive technology by means of a transmission. A predetermined electrical voltage is applied to a stator winding of the stator which is electrically coupled to a control unit so as to cause the door to open at least during temporary support of the plunger head against the door inner face. Finally, the invention relates to a household appliance having a carcass which has an interior space and an access opening for the interior space, a door that is arranged on the carcass in such a manner as to be able to pivot about a pivot axis so as to close the access opening, and a control facility that is arranged on the carcass remote from the pivot axis so as to determine a pressure actuation to the door of the household appliance by a user. The door closes the access opening of the carcass of the household appliance to the interior space of the household appliance in that at least one door inner face of the door is supported on an elastic seal arranged on the carcass and running around the access opening or an elastic seal arranged on the door inner face running around a region of an edge of the access opening.

Generic methods, sensor facilities and household appliances are extensively known in the prior art, so that there is no need for printed evidence in this respect. In the case of many household appliances, it is now common for the door of the household appliance to be opened at least in part automatically by activating a door opening mechanism of the household appliance and opening the door at least by a predeterminable angle based on an opening signal, so that a user can reach behind the door, even if the door is configured without a door handle, and swivel it into the fully open position. It is of course also possible for the door opening mechanism to open the door fully.

Particularly in the case of household refrigeration appliances, it is now common for the door not to have a door handle or a handle for manual actuation by the user. In the case of such household appliances which have a door that does not have a door handle, the user actuates the door, in particular manually, for example by pressing against the door in an edge region of the door. This pressure actuation can be detected by means of a sensor facility of the household appliance which then provides an appropriate opening signal for a door opening mechanism or a door opening apparatus of the household appliance. However, the sensor facility generally requires that an actuation area in which an actuation by the user can be reliably recognized is comparatively limited. Therefore, the point at which actuation by the user can be reliably recognized can only be provided to a very limited extent on the outer face of the door. This sensor area is often located, for example, in the center of a door that is arranged in such a manner as to be able to pivot about a vertical axis on a carcass of the household appliance, and namely on an edge of the door opposite the pivot axis. When the user wishes to open the door, they must therefore ensure that their actuation is directed towards this sensor area. However, this is already unfavorable for household appliances for ergonomic reasons. In particular, if vision is obstructed for a variety of reasons, the sensor area cannot be located by the user, meaning that the user has to test the point at which their actuation is detected with a large number of attempts. This is particularly unfavorable if the sensor area cannot be detected in a tactile manner by the user. This concerns, among other things, users who have a visual impairment, users who want to open the household appliance in the dark and/or the like. This applies in particular, for example, to cooling or refrigeration appliances, especially for household applications, i.e. household cooling appliances or household refrigeration appliances.

Particularly in the case of household cooling appliances or household refrigeration appliances, it is now common practice to design the door without a door handle or without handles. If a user wishes to access the interior space of the household cooling appliance or household refrigeration appliance, they press against the door, for example with one hand, whereupon the sensor facility detects this manual operation and provides a sensor signal by means of which the door opening mechanism is actuated, with which the door is then opened either completely or at least partially. In this context, published, non-prosecuted German patent application DE 10 2014 107 367 A1, for example, discloses a corresponding cooling appliance. Furthermore, U.S. patent publication No. 2018/0187470 A1 discloses a cooling appliance.

Even if the prior art has proven itself, disadvantages remain. In particular, the construction of DE 10 2014 107 367 A1 is comparatively complex in terms of functionality and requires a lot of space. This means that the opening mechanism of DE 10 2014 107 367 A1 can only be positioned at a few selected points on the carcass of the household appliance. The use of a piezo sensor proves to have limited reliability. In addition, it is a nuisance that the door opening mechanisms of both DE 10 2014 107 367 A2 and US 2018/0187470 A1 result in a not inconsiderable amount of energy consumption outside of opening.

Another disadvantage of the prior art is that additional separate sensor facilities have to be provided in order to determine the door opening request based on the pressure actuation of the user against the outer face of the door. This is not only costly but can also lead to reliability problems.

### SUMMARY OF THE INVENTION

The object of the invention is to provide a method or an improved sensor facility that can be realized with little effort and improved reliability.

The invention proposes as a solution a method, a sensor facility and a household appliance according to the independent claims.

Advantageous developments are disclosed by the features of the dependent claims.

In relation to a generic method, the invention proposes that so as to mechanically support the plunger head against the door inner face at least when the door is in the closed state and at least outside of the application of the electrical voltage to the stator winding a force is applied to the plunger by means of a mechanical support unit and by means of a sensor facility which is electrically coupled to the stator winding an induced voltage of the stator winding is detected outside of the application of the electrical voltage to the stator winding. The induced voltage has at least one voltage pulse depending on the first pressure actuation. A first amplitude of the at least one first voltage pulse is compared in a first comparison with a first voltage comparison value and at least a part of a first temporal extent of the first voltage pulse is compared in a second comparison with a first time comparison value. The door opening request is determined depending on comparison results of the first and the second comparison.

In relation to a generic sensor facility, the invention proposes that so as to mechanically support the plunger head against the door inner face at least when the door is in the closed state and at least outside of the application of the electrical voltage to the stator winding a force is applied to the plunger by means of a mechanical support unit and wherein the sensor facility is electrically coupled to the stator winding and is configured so as to detect an induced voltage of the stator winding at least outside of the application of the electrical voltage to the stator winding. The induced voltage has at least one voltage pulse depending on the first pressure actuation. The sensor facility is further configured so as to compare a first amplitude of the at least one first voltage pulse in a first comparison with a first voltage comparison value and at least a part of a first temporal extent of the first voltage pulse is compared in a second comparison with a first time comparison value, and the door opening request is determined depending on comparison results of the first and the second comparison.

In relation to a generic household appliance, the invention proposes that the household appliance has a sensor facility according to the invention.

The invention is based, among other things, on the concept that the electric machine in conjunction with the plunger head, which is temporarily supported against the door inner face, can be used not only to open the door of the household appliance but also to detect a first pressure actuation of a user against the outer face of the door and based on the first pressure actuation to determine the door opening request. In this case, the invention is based, among other things, on the further concept that the first pressure actuation of the user can result in an inductive voltage at the stator winding of the electric machine. The inductive voltage can in particular be dependent upon a force with which the user presses against the outer face of the door, a time period during which the user exerts the first pressure actuation, and also on a position at which the user exerts the first pressure actuation on the outer face of the door. Furthermore, the invention utilizes, among other things, the knowledge that not every pressure actuation needs to be by a user and that under certain circumstances the pressure actuation of the user is not associated with a door opening request. In order to distinguish these pressure actuations from pressure actuations of the user that are associated with the door opening request, the invention provides for further evaluation of the induced voltage. In relation to at least the first comparison, it is possible to provide that an amount of the first voltage pulse is taken into consideration for the comparison. The amount of a respective voltage pulse can be determined, for example, by means of rectification. It can also be provided that the first voltage comparison value is selected with respect to the polarity depending on the first voltage pulse and the performance of the first comparison is adapted accordingly.

Since the electric machine is a rotating electric machine, a continuous longitudinal movement of the plunger would result in a corresponding direct voltage or an alternating voltage at the stator winding of the electric machine. However, since the movement of the plunger in the intended application is generally associated with a comparatively short stroke, this generally results in only one voltage pulse or a small number of pulses or voltage pulses based the inductive voltage. A voltage pulse can, for example, correspond to a half-wave of an alternating voltage if the plunger were to be moved at a constant speed. It has been shown that a first pressure actuation, which is to be associated with a door opening request, generally leads to an amplitude of a first voltage pulse of the induced voltage that reaches at least a predetermined first voltage comparison value. By performing a first comparison operation, a first condition can thus be determined which is generally associated with a first pressure actuation which in turn is associated with a door opening request. However, this value in itself is not sufficient to determine the door opening request by the first pressure actuation with a high degree of reliability. Rather, it has been shown that it is expedient to compare a first temporal extent of the first voltage pulse at least in part in a second comparison with a predetermined first time comparison value. The second comparison is aimed at checking a minimum temporal extent of the first voltage pulse. This condition is only considered to be fulfilled if the time extent of the first voltage pulse is greater than the first time comparison value. The door opening request can be determined depending on the aforementioned comparison results of the first and second comparison. The sensor facility can then emit a door opening signal, for example. The invention is therefore aimed at checking at least two independent conditions and only determining the first pressure actuation as a door opening request when both conditions are fulfilled.

Furthermore, it is possible to provide that a predetermined detection time period is started at the point in time at which the first voltage pulse is greater for the first time than the first voltage comparison value. The detection time period can extend, for example, over a time period of approx. 0.5 s or also approximately 1 s. During the detection time period, it is possible on a number of occasions for the first voltage pulse to be greater or smaller than the first voltage comparison value. Those time periods during which the voltage pulse is greater than the first voltage comparison value can be totaled to form a total time value which is then compared in the second comparison with the first time comparison value. These time periods can, for example, be recorded discretely in time, among other things, by means of discrete-time sampling or the like, so that the instantaneous values of the induced voltage are recorded that are greater than the voltage comparison value or correspond to the voltage comparison value. For example, a clock rate of around 2 ms or less can be provided for the sampling. In this further development, it can therefore be taken into consideration that the first voltage pulse can also have an irregular, distorted time curve. Such a voltage pulse can also be determined as a door opening request, provided this results from the comparison results of the first and second comparison.

Since the induced voltage is non-uniform and usually does not have an ideal form, the discrete-time recording of induced voltage values can be particularly advantageous. Discrete-time induced voltage values are understood to be a countable form of the induced voltage over a time period. Discrete-time recorded voltage values refer to a measuring method in which the voltage is sampled or measured at specific points in time or moments within a detection time period. In this case, the voltage values are only recorded at discrete points in time or moments. Consequently, the sensor signals can be totaled by a counter and when a minimum threshold value or a proportion of instantaneous values of the induced voltage of a voltage pulse corresponding to the voltage comparison value is reached, the door opening request can be determined by a control unit. The minimum threshold value or at least the proportion of instantaneous values in the detection period that correspond to the voltage comparison value can, for example, be a value of 300 for 1000 samples, so that the second comparison or the comparison of the temporal extent of a voltage pulse with a time comparison value is positive.

A voltage pulse can preferably be characterized by the fact that a time curve of a voltage value of the voltage pulse does not have a polarity change. The voltage pulse can therefore have, for example, an irregular time curve of the voltage value, wherein only one polarity is present.

Accordingly, the sensor facility is configured so as to be able to carry out the method according to the invention. For this purpose, the sensor facility is electrically coupled to the stator winding and is configured to detect the induced voltage of the stator winding at least outside of the application of the electrical voltage to the stator winding. This ensures that the electrical voltage, which is generally applied to the stator winding so as to carry out the door opening process, does not interfere with the detection of the inductive voltage. The sensor facility can therefore be at least in part integrated into a control facility for the door opening apparatus without significant technical effort. However, it can also be provided as a separate module that can be connected to the control facility or, if necessary, also directly to the stator winding. This means that it is not necessary to provide additional sensors in order to determine the door opening request. This also applies in particular to the household appliance, which is why the invention is also suitable for retrofitting to existing household appliances or corresponding appliance designs.

The invention is, among other things, preferably also based on the fact that the plunger head can already rest against the door inner face when the door is in the closed state. The door opening apparatus can thus not only be used to cause the door of the household appliance to open, but it is also possible to use it as a sensor for an open state of the door, a first pressure actuation of a user and/or the like, so that, among other things, a door opening wish or a door opening request of the user can also be detected. As a result, it is no longer necessary to provide a separate sensor unit for this purpose compared to the prior art. The separate sensor unit can be completely dispensed with because, for example, the door opening apparatus itself, in particular if it comprises the sensor facility, can also provide the sensor functionality at the same time.

The invention can achieve this in that, among other things, when the door is in the closed state the plunger or its plunger head is supported on the door inner face or rests against or touches it. This makes it possible, among other things, that the plunger does not need to perform a stroke until it contacts the door inner face. Therefore, among other things, the first pressure actuation by the user, which can manifest itself at least in a slight movement of the door, can also be detected by means of the plunger, wherein the door opening apparatus can detect the movement of the plunger caused by this. The detection process is preferably coupled to a situation in which the electrical voltage is not applied to the stator winding by a control unit of the door opening apparatus. This also makes it possible to use the stator winding to detect a stroke of the plunger by detecting an induced voltage. The induced voltage can be evaluated accordingly. This explains why the mechanical support unit applies a force to the plunger so that the plunger head is mechanically supported against the door inner face. In contrast to the prior art, it is therefore preferable in the case of the invention that there is constant mechanical contact between the plunger head and the door inner face when the door is in the closed state.

In this context, “door open” means that the door is no longer closed.

The electric machine can be configured, for example, as a single-phase or multi-phase alternating voltage machine, as a step motor or also as a direct voltage machine. In order to cause the door to open, the electrical voltage is applied to the stator winding of the electric machine or the stator of the electric machine by the control unit. This creates a motor effect that is converted into a translational force on the plunger via the transmission, so that the plunger can be subjected to a force in the direction of the door inner face that is suitable for causing the door to open. Since only a temporary support of the plunger head against the door inner face is provided, it is then possible that the plunger only needs to be moved by a small stroke in order to push the door open so that the user can reach behind one edge of the door and thus open the door completely. In this context, the transmission is preferably configured in such a way that it cannot only convert a rotational movement of the rotor into a translational movement of the plunger, but can also convert a translational movement of the plunger into a rotational movement of the rotor.

The plunger, in particular the plunger head, therefore does not need to be permanently mechanically fixedly connected to the door inner face or the door. As soon as the user closes the door, the plunger can, for example, be moved back into an initial position by means of the closing movement, in that the door inner face presses against the plunger head and moves it along until the door is fully closed. However, it is also possible to provide that after the door has been opened by applying a further, different electrical voltage to the stator winding, the plunger is actively moved into a retracted position and only after the door has been closed is the force applied again by means of the mechanical support unit, so that the plunger head is moved towards the door inner face until it rests against the door inner face.

The plunger can have at least one round or one angular cross-sectional shape. It is preferably circular or rectangular in shape. The cross-sectional shape of the plunger is preferably essentially constant over its axial extent. In the region of the first end, however, this can also be different. The plunger head can have the same cross-sectional shape as the plunger. However, the plunger head can also have a curved spherical shape. In terms of a cross-sectional area, the plunger head can be smaller or larger than a cross-sectional area of the plunger in the longitudinal extent

The electric machine is generally configured as a rotating or rotatable electric machine and is also extensively known in the prior art, so that separate documentary evidence is not required in this respect or for the household appliance. A rotating electric machine is an apparatus that converts electrical energy into mechanical energy, in particular rotational energy, in motor mode and/or mechanical energy into electrical energy in generator mode. The movement is generally a rotary movement that is performed by a rotor of the rotating electric machine that is arranged so as to be able to rotate relative to a stator of the rotating electric machine. In contrast to the rotor, the stator is generally fixed in terms of rotation, i.e. a rotary movement is a rotary movement of the rotor relative to the stator. The rotor is mounted so as to be able to rotate relative to the stator, wherein an air gap is usually formed between the rotor and the stator.

In normal operation, the stator and the rotor are linked by means of a magnetic flux, which in the motor operation provides the force or torque that drives the rotor to rotate relative to the stator. In the generator mode, mechanical energy supplied to the rotor in the form of rotation in conjunction with a torque is converted into electrical energy. For this purpose, at least the stator has an electrical winding through which an electric current flows, also known as a stator winding. The rotor can also have an electrical winding as the rotor winding and/or one or more permanent magnets.

For the normal operation in order to open the door, the electrical voltage is applied to the stator winding. Depending on the construction of the electric machine, in particular its stator winding, a single-phase or also a multi-phase stator winding can be provided, for example, for the application of an alternating voltage, which is accordingly supplied with a single-phase or multi-phase electrical alternating voltage. A multi-phase alternating voltage generally has alternating phase voltages that correspond to the number of phases and generally have approximately the same frequency and approximately the same amplitude, but are shifted in relation to each other in terms of their phase position. A very common multi-phase alternating voltage is, for example, a three-phase alternating voltage in which the phase voltages are each shifted by 120° in phase to each other. This type of alternating voltage is also used in the public power grid, for example.

The control unit is preferably configured as an electronic hardware circuit and can have a program-controlled computer unit in order to realize the desired functionality. In particular, the control unit, especially the hardware circuit, can have a DC converter, an inverter and/or the like for applying the electrical voltage to the stator winding. Of course, the control unit can also be formed solely by the computer unit or also have a combination of a hardware circuit with the computer unit. In principle, however, it is also possible for the control unit to comprise only a hardware circuit. The control unit can also be at least in part included in a higher-level control unit of the household appliance. However, it can also be provided as a separate component in the household appliance. In particular, it is provided at least in part as a component of the door opening apparatus.

In order to provide the sensor functionality, the door opening apparatus provides, for example, the control unit, the sensor facility, in particular the circuit arrangement of the sensor facility which is electrically coupled to the stator winding. This means that the induced voltage of the stator winding can be detected by means of the sensor facility outside of the application of the electrical voltage to the stator winding by the control unit. The detected electrical voltage can then be at least in part evaluated by the sensor facility or also at least in part by the control unit. In particular, the evaluation can be used to determine whether a user has requested the door to be opened, whether the door is being closed and/or similar. The control unit can be configured to electrically couple the stator winding only to the sensor facility, in particular to the circuit arrangement, outside of the application of the electrical voltage. A suitably configured switching unit can be provided for this purpose. However, it is also possible for the circuit arrangement to be permanently electrically coupled to the stator winding and for switching elements of the inverter to be switched to a switched-off switching state outside of the application of electrical voltage to the stator winding. This can also enable the induced voltage to be detected by the circuit arrangement. If required, the electrical coupling can be provided with a galvanic isolation unit in order to realize electrical potential isolation between the stator winding and the circuit arrangement.

According to a further development, it is proposed that the first temporal extent of the first voltage pulse is determined in relation to the first voltage comparison value. In particular, it is proposed that only the time period for which a voltage value is greater than the first voltage comparison value is taken into consideration for the first temporal extent of the first voltage pulse. In particular, this function can relate to comparing corresponding magnitude values with one another. In this context, rectification of the induced voltage can therefore be provided, for example.

According to a further development, it is proposed that the first amplitude is compared in a third comparison with a second voltage comparison value, and the door opening request is additionally determined depending on the comparison result of the third comparison. Preferably, the second voltage comparison value is greater than the first voltage comparison value and the door opening request is determined in such a way that the first amplitude is smaller than the second voltage comparison value if the comparison is to be able to confirm the door opening request. This makes it possible to ensure that a first pressure actuation, which has a greater value depending on the second voltage comparison value, does not result in this first pressure actuation being determined as a door opening request. Rather, it can be achieved that a door opening request is only determined to be present if the amplitude in the first comparison is greater than the first voltage comparison value and in the third comparison is less than the second voltage comparison value. This can further improve the determination of the door opening request. In principle, an adaptation of the second voltage comparison value and the execution of the third comparison can also be adapted here depending on the polarity of the first voltage pulse or the magnitude of the first voltage pulse can be used for the comparison.

In addition, it is proposed that the induced voltage has at least one second voltage pulse depending on the first pressure actuation. A second amplitude of the at least one second voltage pulse is compared in a fourth comparison with a third voltage comparison value and a total value formed from at least the part of the first temporal extent of the first voltage pulse and at least a part of a second temporal extent of the second voltage pulse is compared in the second comparison with the first time comparison value. The door opening request is determined at least additionally depending on comparison results of the second and fourth comparison. The door opening request can be determined in the case of more than a single voltage pulse, preferably additionally or exclusively, depending on the total value of the respective time extents of the, preferably successive, individual pulses. It may be provided, for example, that a respective temporal extent of a respective individual voltage pulse is only taken into consideration in the total if at least its respective amplitude is greater than the respective corresponding voltage comparison value and/or its respective temporal extent is greater than the respective corresponding time comparison value. In particular, it may be provided that the total value only takes into consideration the temporal extent of those voltage pulses whose amplitude is greater than the respective voltage comparison value. Preferably, the door opening request is determined exclusively depending on the total value.

Moreover, it is proposed that the induced voltage has at least one second voltage pulse depending on the first pressure actuation, wherein a second amplitude of the at least one second voltage pulse is compared in a fourth comparison with a third voltage comparison value and an at least in part second temporal extent of the second voltage pulse is compared in a fifth comparison with a second time comparison value. The door opening request is additionally determined depending on the comparison results of the fourth and the fifth comparison. The second voltage pulse can, for example, be a voltage pulse that immediately follows the first voltage pulse. In particular, the second voltage pulse can have an inverted polarity in relation to the first voltage pulse. The fourth and, if applicable, the fifth comparison are adapted accordingly, as are the third voltage comparison value and the second time comparison value. However, it may also be provided that a rectification functionality is provided at least in relation to the second voltage pulse, so that the polarity in relation to the fourth comparison can essentially correspond to the first comparison. In principle, the first and third voltage comparison values can, of course, be the same. However, it has been shown that the second voltage pulse generally has a smaller amplitude and a shorter duration than the first voltage pulse. It is therefore preferable for the third voltage comparison value to be selected in a correspondingly adapted manner compared to the first voltage comparison value. The same can also be provided for the second time comparison value. According to the knowledge of the inventors, the second voltage pulse is generally shorter than the first voltage pulse. For the fifth comparison, it is therefore expedient to select the second time comparison value to be smaller than the first time comparison value. In principle, however, the second comparison value could also be selected to correspond to the first time comparison value. Preferably, the door opening request is additionally determined depending on the comparison results of the fourth and fifth comparison. Only when these comparisons also lead to corresponding comparison results is the first pressure actuation recognized as a door opening request in this embodiment.

Furthermore, it is proposed that the second temporal extent of the second voltage pulse is determined in relation to the third voltage comparison value. Corresponding to the process control in relation to the first voltage pulse, it can therefore also be provided here that only the temporal extent of the second voltage pulse is taken into consideration for the fifth comparison, in which the second amplitude of the second voltage pulse reaches the third voltage comparison value in the fourth comparison. This also makes it possible to further improve the reliability in terms of determining the door opening request.

Furthermore, it is proposed that the second amplitude is compared in a sixth comparison with a fourth voltage comparison value and that the door opening request is additionally determined depending on the comparison result of the sixth comparison. The above considerations apply accordingly to the question of polarity. In accordance with the method in relation to the first voltage pulse, it can also be provided for the second voltage pulse that the second voltage pulse should not exceed a maximum predetermined amplitude if a door opening request is to be present due to the first pressure actuation.

It is also proposed that at least one magnitude of the voltage pulse is used for each of the first, third, fourth or sixth comparison. This enables simple process control and the use of uniform hardware, for example by realizing the comparison operation with a single hardware circuit for all comparisons, in which the respective amplitudes are compared with the respective comparison voltages in the time-division multiplex. The comparator circuit can be used in time-division multiplexing, for example. This allows a particularly low hardware effort to be realized.

It is further proposed that a door opening request is determined by a second pressure actuation of the user against the outer face of the door immediately following the first pressure actuation. The induced voltage has at least one third voltage pulse depending on the second pressure actuation, wherein a third amplitude of the at least one third voltage pulse is compared in a seventh comparison with the second voltage comparison value and at least a part of a third temporal extent of the third voltage pulse is compared in an eighth comparison with a third time comparison value. The door opening request is additionally determined depending on the comparison result of the seventh and eighth comparison. Accordingly, it is possible that the door opening request is determined not only based on a single pressure actuation but rather based on an additional second pressure actuation. It has been shown that the user intuitively presses with greater pressure on the outer face of the door during the second pressure actuation, so that the third amplitude of the third voltage pulse is at least greater than the first amplitude of the first voltage pulse or greater than the second voltage comparison value. On the other hand, the temporal extent of the third voltage pulse is shorter than the temporal extent of the first voltage pulse. The third voltage pulse can, for example, be a voltage pulse that immediately follows the first or second voltage pulse of the first pressure actuation. The seventh and, if applicable, the eighth comparison are adapted accordingly, as are the second voltage comparison value and the third time comparison value. However, it may also be provided that a rectification functionality is provided at least in relation to the second voltage pulse, so that the polarity in relation to the seventh comparison can essentially correspond to the first comparison. It is therefore preferable for the second voltage comparison value to be selected in a correspondingly adapted manner compared to the first voltage comparison value. The same can also be provided for the third time comparison value. According to the knowledge of the inventors, the third voltage pulse is generally shorter than the first voltage pulse. For the eighth comparison, it is therefore expedient to select the second time comparison value to be smaller than the first time comparison value. In principle, however, the third time comparison value could also be selected to correspond to the first time comparison value. Preferably, the door opening request is additionally determined depending on the comparison results of the seventh and eighth comparison. Only when these comparisons also lead to corresponding comparison results is the first pressure actuation recognized in this embodiment as a door opening request in conjunction with the second pressure actuation. This has the advantage that the door opening request can be determined even more reliably and is better adapted to user behavior.

Moreover, it is proposed that the induced voltage has at least one fourth voltage pulse depending on the second pressure actuation. A fourth amplitude of the at least one fourth voltage pulse is compared in a ninth comparison with the fourth voltage comparison value and at least a part of a fourth temporal extent of the fourth voltage pulse is compared in a tenth comparison with a fourth time comparison value. The door opening request is additionally determined depending on the comparison result of the ninth and the tenth comparison. Accordingly, it is possible that the door opening request is determined not only based on a single pressure actuation but rather based on an additional second pressure actuation. It has been shown that the user intuitively presses with greater pressure on the outer face of the door during the second pressure actuation, so that the fourth amplitude of the fourth voltage pulse is normally greater than the second amplitude of the second voltage pulse or smaller than the fourth voltage comparison value. On the other hand, however, the temporal extent of the fourth voltage pulse is normally at least shorter than the temporal extent of the first and/or second voltage pulse. The fourth voltage pulse can, for example, be a voltage pulse that immediately follows the third voltage pulse. In particular, the fourth voltage pulse can have an inverted polarity in relation to the third voltage pulse. The ninth and, if applicable, the tenth comparison are adapted accordingly, as are the fourth voltage comparison value and the fourth time comparison value. However, it may also be provided that a rectification functionality is provided at least in relation to the fourth voltage pulse, so that the polarity in relation to the ninth comparison can essentially correspond to the seventh comparison. In principle, the second and fourth voltage comparison values can of course be the same. However, it has been shown that the fourth voltage pulse generally has a smaller amplitude and a shorter duration than the third voltage pulse. It is therefore preferable for the fourth voltage comparison value to be selected in a correspondingly adapted manner compared to the second voltage comparison value. The same can also be provided for the fourth time comparison value. According to the knowledge of the inventors, the fourth voltage pulse is generally shorter than the second or third voltage pulse. For the tenth comparison, it is therefore expedient to select the fourth time comparison value to be smaller than the second time comparison value or even smaller than the third time comparison value. In principle, however, the fourth time comparison value could also be selected to correspond to the third time comparison value. Preferably, the door opening request is additionally determined depending on the comparison results of the ninth and tenth comparison. Only when these comparisons also lead to corresponding comparison results is the first pressure actuation recognized in this embodiment as a door opening request in conjunction with the second pressure actuation. This has the advantage that the door opening request can be determined even more reliably and is better adapted to user behavior.

Furthermore, it is proposed that the door opening request in the case of more than a single voltage pulse is determined depending on the total value of the respective temporal extent of immediately successive individual pulses. This makes it possible to ensure that only those voltage pulses that can be attributed to a single pressure actuation are taken into consideration. In this way, it is possible to distinguish between different successive pressure actuations.

The door opening request can be determined in the case of more than a single voltage pulse or pressure actuations, preferably additionally or exclusively, depending on the total value of the respective time extents of the, preferably successive, individual pulses. It may be provided, for example, that a respective temporal extent of a respective individual voltage pulse is only taken into consideration in the total if at least its respective amplitude is greater than the respective corresponding voltage comparison value and/or its respective temporal extent is greater than the respective corresponding time comparison value. In particular, it may be provided that the total value only takes into consideration the temporal extent of those voltage pulses whose amplitude is greater than the respective voltage comparison value. Preferably, the door opening request is determined exclusively depending on the total value.

It is also proposed that at least one of the comparisons is realized by means of an analogue hardware circuit. In this way, very fast and reliable signal processing can be achieved. Only a small amount of hardware is required for the proposed process control, for example using one or more comparators. In principle, however, it is also possible to carry out the comparison operations with the assistance or even exclusively using a program-controlled computer unit.

It is also proposed that at least the second or the fifth comparison is realized by means of a digital hardware circuit. Furthermore, it may be provided that the eighth and/or tenth comparison is also realized by means of a digital hardware circuit. The digital hardware circuit can be particularly suitable for fast signal processing, in particular for comparing the respective time extent of the respective voltage pulse with the respective time comparison value. Such a hardware circuit can be realized, for example, using flip-flop circuits, such as a monostable flip-flop circuit or the like. In principle, however, it is also possible here to realize at least part of the functionality by means of a program-controlled computer unit.

It is also proposed that at least one magnitude of the voltage pulse is used for each of the first, third, fourth or sixth comparison and for the seventh or the ninth comparison. This enables simple process control and the use of uniform hardware, for example by realizing the comparison operation with a single hardware circuit for all comparisons, in which the respective amplitudes are compared with the respective comparison voltages in the time-division multiplex. The comparator circuit can be used in time-division multiplexing, for example. This allows a particularly low hardware outlay to be realized.

The elastic seal of the household appliance can comprise a magnet that adheres to a metal edge of the access opening of the carcass of the household appliance when the door is in the closed state. The magnet can be a magnetic strip which extends along the elastic seal and thus preferably adheres completely around the access opening of the carcass.

The advantages and effects stated for the method according to the invention also apply equally to the sensor facility according to the invention and to the household appliance that is equipped with the sensor facility according to the invention and vice versa. As a result, device features can, of course, also be formulated as method features and vice versa.

The features and feature combinations mentioned above in the description and the features and feature combinations mentioned below in the description of the figures and/or only illustrated in the figures cannot only be used in the respectively mentioned combination but rather can also be used in other combinations without departing from the scope of the invention. Thus, embodiments which are not explicitly shown and explained in the figures but which emerge from the explained embodiments and can be produced by separate combinations of features are also to be regarded as included and disclosed by the invention. Embodiments and combinations of features are also to be regarded as disclosed which thus do not have all the features of an originally formulated independent claim. Furthermore, embodiments and combinations of features are to be regarded as disclosed, in particular by the embodiments set out above, which go beyond or deviate from the combinations of features set out in the references of the claims.

Other features which are considered as characteristic for the invention are set forth in the appended claims.

Although the invention is illustrated and described herein as embodied in a method for determining a door opening request, a sensor facility for this purpose and a household appliance, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, perspective view of a household refrigeration appliance;

FIG. 2 is perspective view of a door opening apparatus for the household refrigeration appliance according to FIG. 1;

FIG. 3 is an enlarged, sectional view of an area Ill shown in FIG. 2;

FIG. 4 is a perspective exploded representation of a front-side section of the household refrigeration appliance according to FIG. 1, wherein in addition a door opening apparatus and connecting unit for connecting the door opening apparatus is provided with a carcass of the household refrigeration appliance above an access opening of the household refrigeration appliance;

FIG. 5 is a perspective view such as FIG. 4 of the door opening apparatus that is arranged on the carcass of the household refrigeration appliance;

FIG. 6 is a perspective view such as FIG. 4 of the arrangement of the door opening apparatus below an access opening of the household refrigeration appliance;

FIG. 7 is a perspective view such as FIG. 6 of the door opening apparatus that is arranged on the carcass of the household refrigeration appliance;

FIG. 8 is a plan view of a side view of the door opening apparatus according to FIG. 2;

FIG. 9 is a plan view of a rear view of the door opening apparatus according to FIG. 2;

FIG. 10 is a schematic circuit diagram view of a first section of a circuit arrangement of a sensor facility of the door opening apparatus according to FIG. 2;

FIG. 11 is a schematic diagram representation with a first graph of an induced voltage of a stator winding of an electric machine of the door opening apparatus according to FIG. 8 in the case of a pressure actuation of a user as a door opening request;

FIG. 12 is a schematic diagram representation such as FIG. 11 with a second graph of a further pressure actuation which is not a door opening request;

FIG. 13 is a schematic diagram representation such as FIG. 11 with a third graph of a further pressure actuation which is also not a door opening request;

FIG. 14 is a schematic diagram representation with a fourth graph of a first pressure actuation such as FIG. 11 and an immediately following second pressure actuation of a user as a door opening request;

FIG. 15 is a block diagram representation of a further section of the sensor facility according to FIG. 10; and

FIG. 16 is a flow diagram for determining a door opening request.

### DETAILED DESCRIPTION OF THE INVENTION

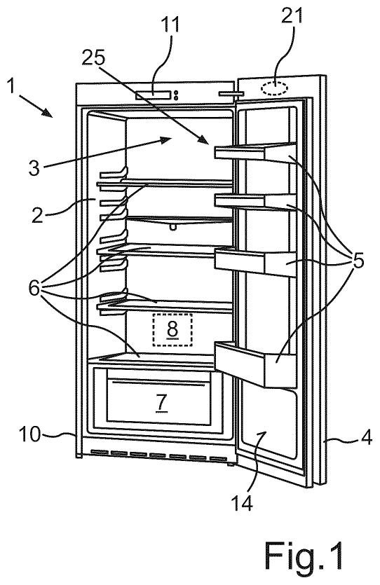

Referring now to the figures of the drawings in detail and first, particularly to FIG. 1 thereof, there is shown a schematic perspective representation of a household refrigeration appliance 1 which has a thermally insulated body or carcass 10 with an interior container which limits a coolable interior space 3. The coolable interior space 3 is provided for storing foodstuffs that are not further illustrated.

The household refrigeration appliance 1 has in the present exemplary embodiment a pivotable door 4 for closing the coolable interior space 3. The door 4 is pivotably mounted with respect to a vertically extending axis. When the door 4 is open, as illustrated in FIG. 1, the coolable interior space 3 can be accessed from outside. Multiple door shelves 5 for storing foodstuffs are arranged on the side of the door 4 that faces the coolable interior space 3. Multiple shelves 6 for storing foodstuff are arranged in the coolable interior space 3, and a drawer 7, in which foodstuff can also be stored, is arranged in the lower region of the coolable interior space 3. The household refrigeration appliance 1 contains a coolant circuit (not illustrated) for cooling the coolable interior space 3.

The household refrigeration appliance 1 also has an electronic control facility 8 which is configured so as to operate the coolant circuit in such a manner that the coolable interior space 3 achieves at least approximately a predetermined or predeterminable target temperature. The electronic control facility 8 is configured in such a manner that it records a prevailing temperature of the interior space 3 by means of a temperature sensor (not illustrated), compares it with the predetermined or predeterminable target temperature and depending on the comparison outputs at least one control signal for the coolant circuit.

Furthermore, the household refrigeration appliance 1 has a door opening apparatus 11. This is arranged approximately in the center above an access opening of the body 10, by means of which a user can access the interior space 3 when the door 4 is open. In the present case, the door 4 is designed for manual actuation by the user without handling. If the user wishes to be able to access the interior space 3 of the household refrigeration appliance 1, they apply pressure as an actuation to the outer face (not illustrated) of the door 4 in the closed state. The door opening apparatus 11 provides an appropriate sensor functionality which is further explained below, so that the door opening apparatus 11 can detect a manual actuation of the user. For this purpose, the door opening apparatus 11 has a sensor facility 61. Based on the detection, a drive that is likewise further explained below and acts on a door inner face 14 of the door 4 in the closed state is actuated and moves the door at least in part into an open state. The user can then grip behind the door that is open at least with a gap and swing the door 4 fully open. Consequently, the user then has clear access to the interior space 3 via the access opening 25. Once access is complete, the user can swing the door 4 back into the closed position by manually actuating it again. In this embodiment, support for the actuation for this purpose is not provided.

The door 4 is used to close the access opening 25, wherein the door 4 is arranged or articulated so as to be able to pivot about a vertical axis on the body 10 in a first region of an edge of the access opening 25. In the present case, the articulation is provided on the right-hand side of the body 10, as illustrated in FIG. 1.

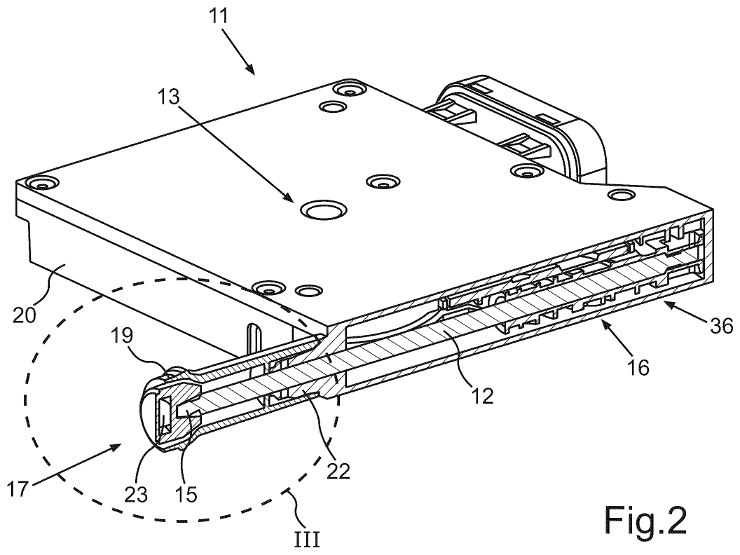

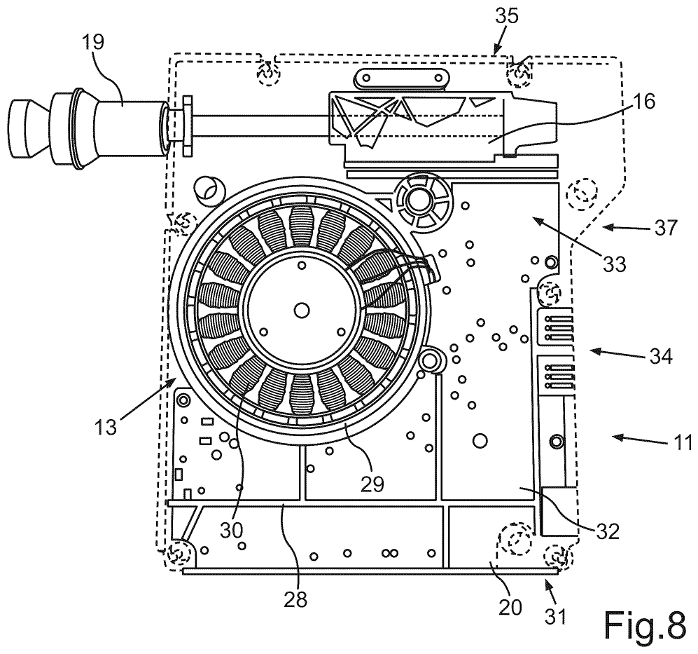

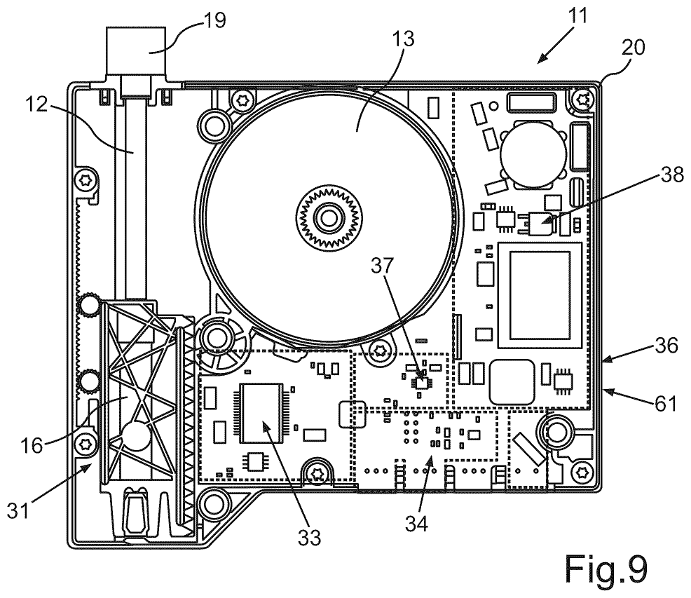

FIG. 2 shows a schematic perspective representation of a door opening apparatus 11 for the household refrigeration appliance 1 according to FIG. 1. FIG. 8 shows the door opening apparatus 11 in a schematic plan view as a side view. FIG. 9 shows the door opening apparatus 11 in a schematic side view lying opposite with regard to FIG. 8. It is apparent that the door opening apparatus 11 has a housing 20 in which the corresponding elements and units of the door opening apparatus 11 are arranged. In a front region in FIG. 2, which will be explained in more detail below, the door opening apparatus 11 is illustrated in section.

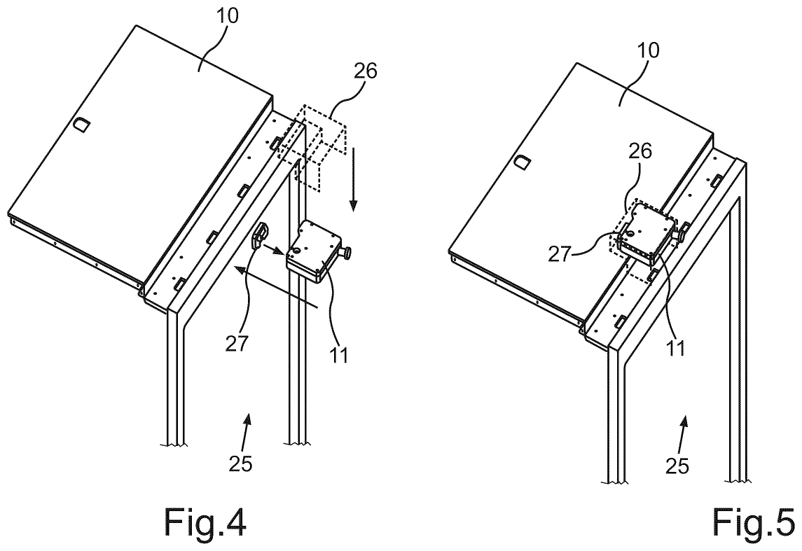

It is apparent that a plunger 12 of the door opening apparatus 11 is arranged in the sectioned area of FIG. 2 and when the door opening apparatus 11 is in the intended installation position the plunger 12 is arranged in relation to a longitudinal axis 18 in a transverse manner with respect to the door inner face 14 in the closed state of the door 4 and axially movable (FIGS. 4 to 7). The plunger 12 has on the door side a first plunger end with a plunger head 15. Moreover, a rotating electric machine 13 which has a rotor 29 that is arranged so as to be able to rotate with respect to a stator 28 is arranged within the housing 20. The rotating electric machine 13 is designed in the present case as an outer rotor (FIG. 8). In alternative embodiments, however, it is also possible to provide a rotating electric machine that is designed as an inner rotor.

The rotor 29 and the plunger 12 are mechanically coupled by means of a transmission 16 in order to be able to provide a mechanical coupling in terms of drive technology between the rotor 29 and the plunger 12. Moreover, a stator winding 30 of the stator 28 is electrically coupled to the control facility 8. In the present case, the stator winding 30 is designed as a three-phase stator winding so that it can be supplied with a three-phase alternating voltage so as to achieve the motor function. As is apparent from FIG. 8, the door opening apparatus 11 has a control unit 36 which is arranged at least in part on a printed circuit board 32 in the housing 20 as an electronic hardware circuit. The control unit 36 has an inverter 33 to which the stator winding 30 is connected. In this way, the stator winding 30 can be supplied with a suitable electrical voltage, which in this case is a three-phase alternating voltage, during normal operation in order to cause the door 4 to open. The control unit 36 also has a power supply unit 38, which is used to supply the control unit 36 and the other units described below. For this purpose, the power supply unit 38 can be coupled to a public energy supply network not illustrated in the figures.

Furthermore, a position sensor 31 is arranged on the printed circuit board 32 as an electronic hardware circuit, by means of which an axial position of the plunger 12 can be detected. For this purpose, a magnet can be arranged on the plunger 12 and the position of the magnet can be detected with a Hall sensor element or a reed pill (not illustrated).

The printed circuit board 32 also has an interface 34, with which the control unit 36 can be coupled to the control facility 8 in terms of communication, signaling and energy.

The control unit 36 is configured to apply an electrical voltage to the stator winding 30 so as to cause the door 4 to open during a temporary support contact of the plunger head 15 against the door inner face 14. The application of electrical voltage results in the electric machine 13 moving the plunger 12 in the direction of the door inner face 14 via the transmission 16 in a motor mode and thus causing the door 4 to open. The housing 20 can be attached to the body 10 of the household refrigeration appliance 1 as explained with reference to FIGS. 4 to 7.

In order to be able to achieve sensor functionality by means of the door opening apparatus 11, it is provided here that the door opening apparatus 11 has a mechanical support unit 17. The support unit 17 is designed to apply a force to the plunger 12 so as to mechanically support the plunger head 15 against the door inner side 14 at least in the closed state of the door 4 and at least outside of the application of the electrical voltage to the stator winding 30. When the door 4 is in the closed state, the plunger head 15 is therefore in contact with the door inner face 14 and touches or makes contact with it.

The plunger 12 is at least in part axially movably arranged in a sleeve 19 that is made of an elastic synthetic material and is closed on the head side (FIG. 2). The sleeve 19 is detachably connected to a housing flange 22 of the housing 20 at an end opposite a head-side end region. As a result, the plunger 12 is arranged in an essentially completely protected manner. The sleeve 19 need not be formed entirely from the elastic material. Rather, it is sufficient if the head-side end region of the sleeve 19 is correspondingly elastic, so that movement of the plunger 12 or the plunger head 15 is possible.

In the present embodiment, it is further provided that the support unit 17 has a magnet 23 for interacting with a magnetizable support area 21 of the door inner face 14, wherein the magnet 23 is arranged on the plunger head 15 (FIG. 2). This makes it possible for the door inner face 14 to be supported or touched or contacted due to the magnetic force effect, at least when the door 4 is in the closed state.

In addition, in the present case the support unit 17 also has a helical spring 24 as a spring element, which also serves to apply the force to the plunger 12 (FIG. 2). Depending on requirements, however, it is possible that the support unit 17 only has one of the elements described above.

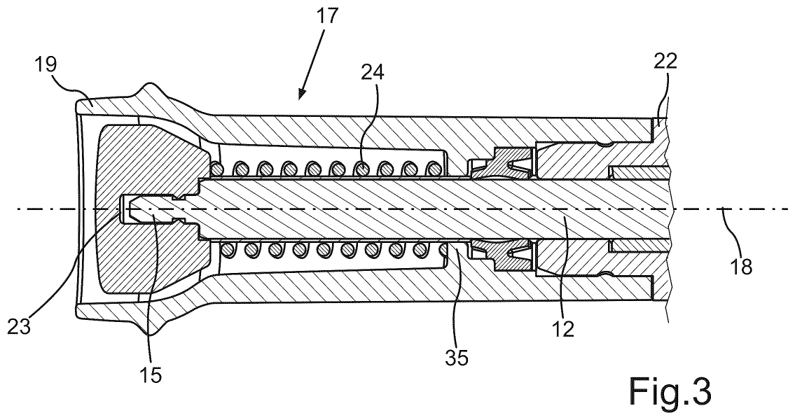

In the present case, the helical spring 24 is arranged inside the sleeve 19, and in fact concentrically in relation to the longitudinal axis 18 of the plunger 12. The plunger 12 protrudes through the helical spring 24, which in turn is supported against a stop 35 at an end facing the housing. This is apparent from a schematically enlarged representation of the area III of FIG. 2 according to FIG. 3. An opposite end of the helical spring 24 is connected to the plunger 12 in the region of the first plunger end or the plunger head 15. This allows a desired force effect to be achieved and, if necessary, adjusted. At the same time, it can be achieved that the helical spring 24 is also completely enclosed by the sleeve 19, so that the helical spring 24 can also be largely protected from external influences. This is apparent in FIG. 3, which shows a schematic, enlarged sectional view of an area III from FIG. 2.

Not illustrated in the figures is that the door opening apparatus 11 can, depending on the construction, also have a stop for limiting a maximum extended position of the plunger head 15. Consequently, it is possible to achieve that the plunger 15 in the extended state, in which the door 4 has been caused to open, protrudes as little as possible into an area in which the user could be located. This can increase safety.

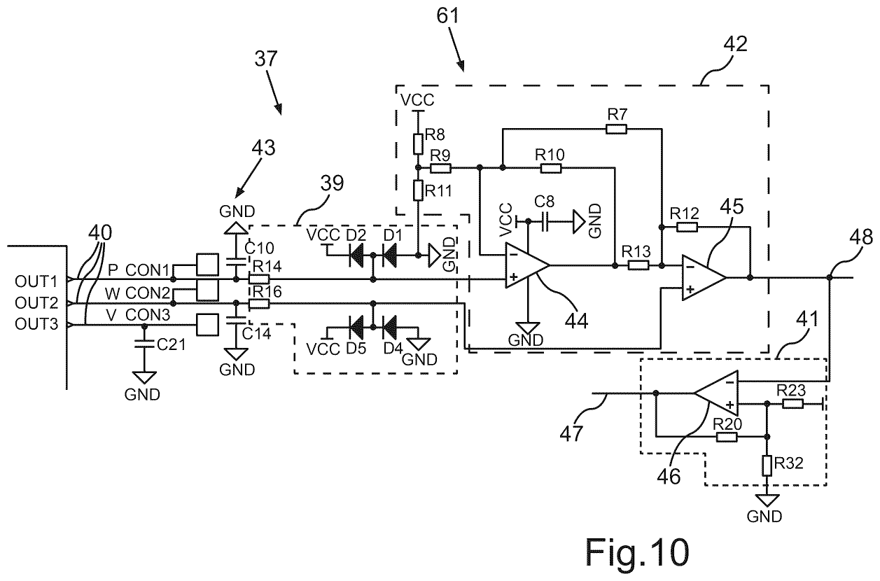

Furthermore, it is provided that the sensor facility 61 is electrically coupled to the stator winding 30 so as to realize the sensor functionality of the door opening apparatus 11. The sensor facility 61 has a circuit arrangement 37 for detecting an induced voltage of the stator winding 30 outside of the application of the electrical voltage to the stator winding 30. A section of the circuit arrangement 37 is shown as a schematic circuit diagram in FIG. 10.

The stator winding 30 is configured for operation on a three-phase alternating voltage as an electrical voltage, in that the stator winding 30 has a respective phase winding for each of the three phases of the alternating voltage. The three measuring connections 40 are each connected to exactly one of the phase windings. However, only the induced voltage between two of the measuring connections 40 is used for the evaluation by the circuit arrangement 37.

Furthermore, the circuit arrangement 37 has a filter unit 43 for filtering the induced voltage detected between the two measuring connections 40. In the present case, a capacitor C10, C14 respectively is provided for this purpose. This allows high-frequency interference signals to be attenuated.

The circuit arrangement 37 has a voltage limiting unit 39 for limiting the electrical voltage between the two measuring connections 40. For this purpose, the voltage limiting unit 39 has two series circuits consisting of diodes D1, D2 and D4, D5, which are connected in the blocking direction to a voltage supply of the circuit arrangement 237. The respective center connections of the series circuits are connected to the respective two measuring connections 40. As a result, a range for the possible electrical potentials of the measuring connections 40 is limited by the electrical potentials of the power supply.

The circuit arrangement 37 also has an amplifier unit 42 for amplifying the electrical voltage between the at least two measuring connections 40, which is connected to the voltage limiting unit 39. The amplifier unit 42 has two operational amplifiers 44, 45, which together form a differential amplifier. The differential amplifier is electrically connected to the measuring connections 40 via the filter unit 43 and the voltage limiting unit 39. The amplifier unit 42 has an amplifier characteristic that results, among other things, from the interaction of the operational amplifiers 44, 45 with other electronic components, in particular the resistors R7 to R13. The amplifier unit 42 provides an amplified output signal at an output connection 48.

The circuit arrangement 37 has a first comparison unit 41 that is connected to the output connection 48 of the amplifier unit 42 so as to compare a first amplitude of a first voltage pulse of the detected induced voltage with a first voltage comparison value U1. A first comparison is realized in this way. The comparison unit 41 has an operational amplifier 46 for this purpose, which realizes a comparator functionality. For this purpose, the operational amplifier 46 interacts with the electrical resistors R20, R23, R32. The comparison unit 41 provides a first comparison signal 47 at a first comparison signal connection 47, which is assigned to a comparison result of the first comparison.

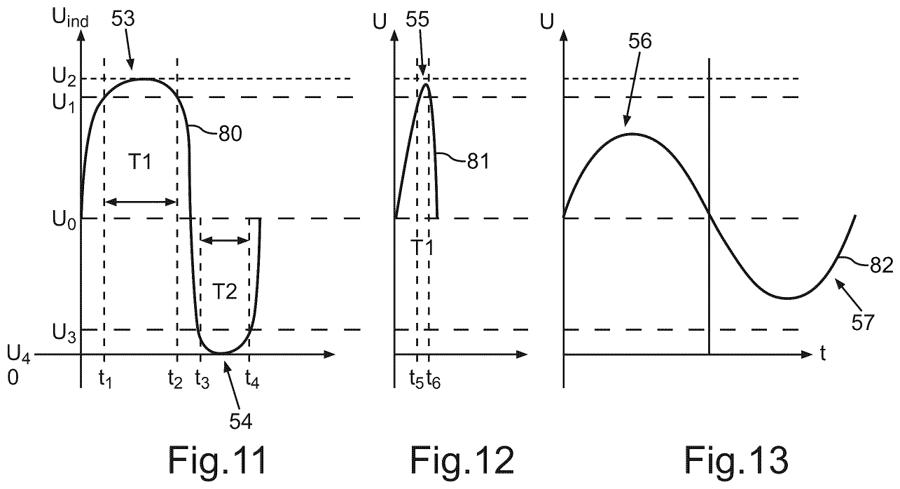

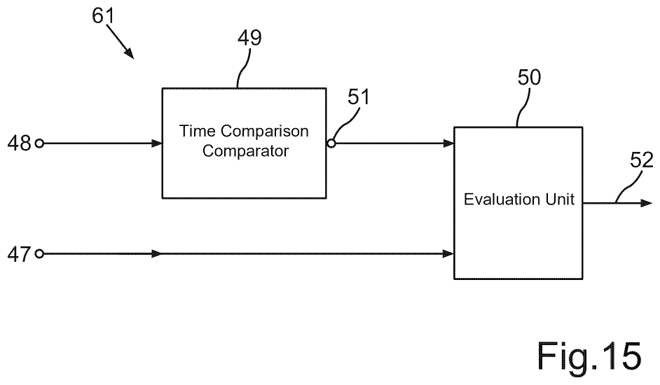

FIG. 15 shows a further section of the sensor facility 61 in a schematic block diagram. FIG. 15 also shows that a time comparison comparator 49 is also connected to the output connection 48 (FIG. 10). The time comparison comparator 49 is configured so as compare an at least in part first temporal extent of the first voltage pulse in a second comparison with a predetermined first time comparison value, as described below in FIGS. 11 to 13. The time comparison comparator 49 has a second comparison signal connection 51, at which the time comparison comparator 49 provides a second comparison signal, which is assigned to a comparison result of the second comparison.

Both the first comparison signal connection 47 and also the second comparison signal connection 51 are connected to an evaluation unit 50, which is designed to determine the door opening request depending on the comparison results of the first and second comparison. If the first voltage pulse reaches the voltage value predetermined by the first voltage comparison value and the second comparison shows that the voltage pulse reaches the predetermined voltage value for the time period predetermined by the first time comparison value, this can be determined by the evaluation unit 50 as a door opening request, whereupon the evaluation unit 50 emits a door opening signal 52. The door opening signal 52 can be detected by the door opening apparatus 11 so that the door opening apparatus 11 causes the door 4 to open.

The function of determining the door opening request is explained further with reference to FIGS. 11 to 13 and 15.

FIG. 11 shows in a schematic diagram representation a voltage-time diagram, in which an abscissa is assigned to the time and an ordinate to the induced electrical voltage. A graph 80 shows a voltage curve of the induced voltage. The induced voltage has a first voltage pulse 53 and a second voltage pulse 54 immediately following it in time.

As is apparent from FIG. 11, the first voltage pulse 53 has an amplitude that is greater than the voltage comparison value U1. A corresponding comparison result of the first comparison is therefore output at the first comparison signal connection 47. Furthermore, it is apparent from FIG. 11 that the first voltage comparison value U1 is present between a point in time t1 and t2, i.e. for a time period T1 that is greater than the predetermined first time comparison value. The corresponding second comparison signal is therefore provided at the second comparison signal connection 51 by the time comparison comparator 49. The first and second comparison signals are evaluated by the evaluation unit 50 and the evaluation unit 50 outputs the door opening signal 52.

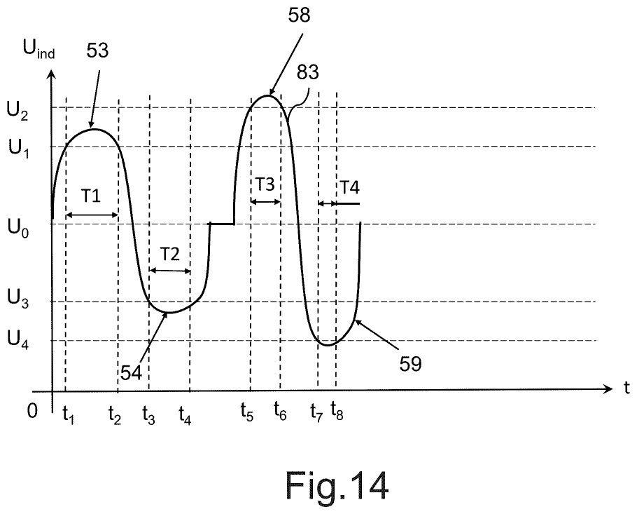

It is not illustrated in the figures that provision can be made for the first voltage pulse 53 to compare the first amplitude in a third comparison with a predetermined second voltage comparison value U2 and to additionally determine the door opening request depending on the comparison result of the third comparison. The circuit arrangement shown in FIGS. 11 and 14 can be supplemented accordingly for this purpose. The second voltage comparison value U2 is greater than the first voltage comparison value U1. In the present case, the evaluation unit 50 only outputs the door opening signal 52 if the first amplitude is also smaller than the second voltage comparison value U2, even if the other comparisons are positive.

FIG. 12 shows a schematic diagram representation such as FIG. 11, in which only a single first voltage pulse 55 is shown by means of a graph 81. As is apparent from FIG. 12, the amplitude of this voltage pulse 55 reaches the first voltage comparison value U1. However, the first voltage comparison value U1 is only reached from a point in time t5 to a point in time t6. The time period T1 determined in this way is smaller than the predetermined first time comparison value. The corresponding comparison result is provided at the corresponding comparison signal connection 51 and evaluated by the evaluation unit 50. The evaluation unit 50 then determines that a door opening request is not present, so that a door opening signal 52 is not output.

However, FIG. 11 also shows a further embodiment of the invention, which is based on the previously explained embodiment. It is apparent from FIG. 11 that the induced voltage has a second voltage pulse 54, which immediately follows the first voltage pulse 53. However, the second voltage pulse 54 has an inverted polarity with respect to the first voltage pulse 53 in relation to an average reference value U0 of the induced voltage. The reliability of the determination of the door opening request can be further improved by additionally taking into consideration the second voltage pulse 54. The circuit arrangements of FIGS. 11 and 14 can be extended accordingly for this purpose by realizing a fourth and fifth comparison corresponding to the first and second comparison. However, the functionality in this respect is adapted accordingly to the inverted polarity of the second voltage pulse 54.

It is apparent from FIG. 11 that the second voltage pulse 54 has a second amplitude that is smaller than a predetermined third voltage comparison value U3. A corresponding comparison result of the fourth comparison is therefore output at the corresponding comparison signal connection. Furthermore, it is apparent from FIG. 11 that the third voltage comparison value U3 is present between a point in time t3 and a point in time t4, i.e. for a time period T2 that is greater than a predetermined second time comparison value. At the corresponding comparison signal connection, for example, the corresponding comparison signal is provided by a corresponding time comparison comparator (not illustrated). In addition to the first and second comparison signal, the corresponding comparison signals based on the fourth and fifth comparison are also taken into consideration by the evaluation unit 50 during the evaluation. The evaluation unit 50 only outputs the door opening signal 52 if corresponding comparison results of all comparisons are available.

In the present embodiment, it is provided that the door opening request is determined depending on whether, in the case of several voltage pulses, each of the immediately successive voltage pulses reaches the respective voltage comparison value. If one of the consecutive voltage pulses does not reach the respective voltage comparison value, the subsequent voltage pulses are preferably no longer taken into consideration for this determination process.

According to a further embodiment, which is also based on FIG. 11, it is provided that the induced voltage has at least one second voltage pulse 54, 57 depending on the pressure actuation, wherein a second amplitude of the at least one second voltage pulse 54, 57 is compared in a fourth comparison with the third voltage comparison value U3 and a total value that is formed from at least the part of the first temporal extent of the first voltage pulse 53, 55, 56 and at least a part of a second temporal extent of the second voltage pulse 54, 57 is compared in the second comparison with the first time comparison value. The door opening request is additionally determined depending on the comparison results of the second and fourth comparison. In this embodiment, the door opening request is therefore preferably determined depending on the first, second and fourth comparison. For this purpose, the total value is determined, which is preferably the total of the respective individual time periods T1 and T2. The total value is then used as the basis for the second comparison. Of course, multiple successive voltage pulses can also be taken into consideration here. Preferably, only immediately successive voltage pulses are taken into consideration. It can also be provided here that if one of the successive voltage pulses does not reach the respective voltage comparison value, the subsequent voltage pulses are preferably no longer taken into consideration for this determination process. If this comparison shows that the total value is greater than the time comparison value, this is recognized as a door opening request.

For the second voltage pulse 54, it is also possible here to compare the second amplitude in a sixth comparison with a predefined fourth voltage comparison value U4 and to additionally determine the door opening request depending on the comparison result of the sixth comparison. The circuit arrangement according to FIGS. 11 and 14 can be supplemented accordingly. The fourth voltage comparison value U4 is smaller than the third voltage comparison value U3. In the present case, the evaluation unit 50 does not output a door opening signal 52 if the second amplitude is smaller than the fourth voltage comparison value U4, even if the other comparisons are positive.

FIG. 13 shows a further schematic diagram representation such as FIG. 11, in which likewise two immediately successive voltage pulses 56, 57 of the induced voltage are shown by means of a graph 82. As is apparent from FIG. 13, the amplitudes of these voltage pulses 56, 57 respectively do not achieve the respective first and third voltage comparison values U1, U3. The corresponding first or fourth comparison supplies at the respective comparison signal connection a comparison signal which corresponds to the respective comparison result and is evaluated by the evaluation unit 50. The evaluation unit 50 then determines that a door opening request is not present, so that a door opening signal 52 is not output.

FIG. 14 shows a further schematic diagram representation in which a first pressure actuation according to FIG. 11 and an immediately subsequent second pressure actuation of a user are shown as a door opening request by means of a graph 83. The first voltage pulse 53 and second voltage pulse 54 of the first pressure actuation correspond to the representation and description of FIG. 11. As is apparent from FIG. 14 for the second pressure actuation, a third amplitude of a third voltage pulse 58 reaches both the first and second voltage comparison value U1, U2 and a fourth amplitude of a fourth voltage pulse 59 reaches both the third and fourth voltage comparison values U3, U4. Consequently, the third amplitude of the third voltage pulse 58 must be greater than the second voltage comparison value U2, so that a seventh comparison is positive. Consequently, the third amplitude of the third voltage pulse 58 is greater than the first amplitude of the first voltage pulse 53, so that the seventh comparison is positive. The fourth amplitude of the fourth voltage pulse 59 is smaller than the fourth voltage comparison value U4 and also smaller than the second amplitude of the second voltage pulse 54, so that a ninth comparison is positive. Furthermore, it is apparent from FIG. 14 that the second voltage comparison value U2 is present between a point in time t5 and t6, i.e. for a time period T3 that is greater than the predetermined third time comparison value, so that an eighth comparison is positive. The time period T3 forms the temporal extent or the part of the instantaneous values of the third voltage pulse 58 that exceeds or corresponds to the second voltage comparison value U2. The fourth voltage comparison value U4 is present at the fourth voltage pulse 59 between a point in time t7 and t8, i.e. for a time period T4 that is greater than the predetermined fourth time comparison value, so that a tenth comparison is positive. The time period T4 thus represents the temporal extent or the part of the instantaneous values of the fourth voltage pulse 59 that is below or corresponds to the second voltage comparison value U4. The corresponding comparison signal is therefore provided at the second comparison signal connection 51 by the time comparison comparator 49. The comparison signals are evaluated by the evaluation unit 50 and the evaluation unit 50 outputs the door opening signal 52. Furthermore, it is apparent that the time period T3 of the third voltage pulse 58 of the second pressure actuation is shorter than the first time period T1 of the first voltage pulse 53 of the first pressure actuation, and likewise the time period T4 of the fourth voltage pulse 59 of the second pressure actuation is shorter than the time period T2 of the second voltage pulse 54 of the first pressure actuation, so that the time comparison values are adapted accordingly for the first pressure actuation and second pressure actuation. In one possible embodiment, the total value formed from T1 to T4 can also be compared as to whether it is equal to or greater than a predetermined time comparison value, so that the presence of a door opening request is determined when the door is actuated with a first and immediately following second pressure actuation. The available comparison signals are evaluated by the evaluation unit 50 and the evaluation unit 50 outputs the door opening signal 52 accordingly.

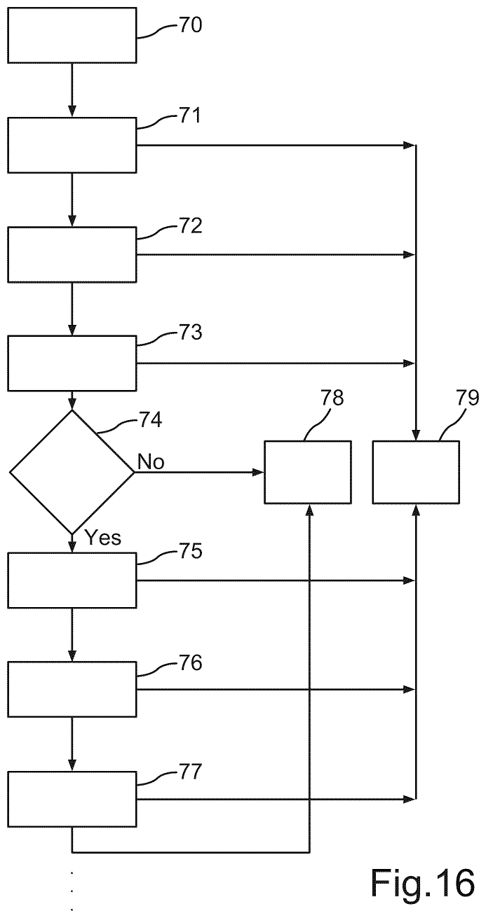

FIG. 16 shows a schematic flow diagram of an embodiment for determining a door opening request. In a step 70, the induced voltage is detected, and a first voltage pulse 53 and a second voltage pulse 54 are determined. In a step 71, an amplitude of the first voltage pulse 53 is compared with the first voltage comparison value U1. If the amplitude of the first voltage pulse 53 is smaller than the first voltage comparison value U1, the method is continued with step 79. In the step 79, it is determined that a door opening request is not present.

If the amplitude of the first voltage pulse 53 is greater than the voltage comparison value U1, the method is continued with step 72. In the step 72, an amplitude of the first voltage pulse 53 is compared with the second voltage comparison value U2. If the amplitude of the first voltage pulse 53 is greater than the second voltage comparison value U2, the method is continued with step 79. If the amplitude of the first voltage pulse 53 is smaller than the second voltage comparison value U2, the method is continued with step 73.

In step 73, a part of a first temporal extent of the first voltage pulse 53 is compared in a second comparison 73 with the first time comparison value. In the present case, the first temporal extent of the first voltage pulse 53 is determined with respect to the first voltage comparison value U1, i.e., the time period T1. If the time period T1 is smaller than the predetermined first-time comparison value, the method is continued with step 79. If the time period T1 is greater than the predetermined first time comparison value, the method is continued with step 74.

A check is performed in step 74 as to whether a further voltage pulse is present. If this is not the case, then the method continues with step 78. In the step 78, it is determined that a door opening request is present.

If, as previously explained, a second voltage pulse is present in the step 74, the method continues with step 75.

In the step 74, an amplitude of the second voltage pulse 54 is compared with the third voltage comparison value U3. It is to be noted in this case that in the present embodiment the second voltage pulse 54 has an inverted polarity in relation to the first voltage pulse 53. The subsequent comparison operations are adapted accordingly. If the amplitude of the first voltage pulse 53 is greater than the third voltage comparison value U3, the method is continued with step 79.

If the amplitude of the second voltage pulse 54 is smaller than the third voltage comparison value U3, the method is continued with step 76. In the step 76, an amplitude of the second voltage pulse 54 is compared with the fourth voltage comparison value U4. If the amplitude of the first voltage pulse 53 is smaller than the fourth voltage comparison value U4, the method is continued with step 79. If the amplitude of the second voltage pulse 54 is greater than the fourth voltage comparison value U4, the method is continued with step 77.

In step 77, a part of a second temporal extent of the second voltage pulse 54 is compared in a fourth comparison 75 with the second time comparison value. In the present case, the second temporal extent of the extent voltage pulse 54 is determined in relation to the third voltage comparison value U3, i.e., the time period T2. If the time period T2 is smaller than the predetermined second time comparison value, the method is continued with step 79. If the total value of the time period T1 and T2 is greater than the predetermined first time comparison value, the method is continued with step 78. In the step 78, the presence of a door opening request is also determined in this case with two voltage pulses in immediate succession.

The door opening signal 52 is only emitted here if all the respective comparison conditions are fulfilled.

The schematic flow diagram according to FIG. 16 can be supplemented accordingly with further comparison steps for a door opening request by a second pressure actuation of the user against the outer face of the door 4 immediately following the first pressure actuation (not illustrated). A third amplitude of the at least one third voltage pulse 58 is compared in a seventh comparison with the second voltage comparison value U2 and at least a part of a third temporal extent of the third voltage pulse 58 is compared in an eighth comparison with a third time comparison value, wherein the door opening request is additionally determined depending on the comparison result of the seventh and eighth comparison. If the third amplitude of the third voltage pulse 58 is smaller than the second voltage comparison value U2, it is determined that a door opening request is not present according to step 79. If the third amplitude of the third voltage pulse 58 is greater than the second voltage comparison value U2, then the seventh comparison is positive. If the time period T3 is smaller than the predetermined third time comparison value, it is likewise determined that a door opening request is not present according to step 79. If the time period T3 is greater than a predetermined third time comparison value, then the eighth comparison is positive. If the seventh and eighth comparison is positive or the presence of a door opening request has been determined, the total value of T1, T2 and T3 can also be determined and compared as to whether it is equal to or greater than the corresponding predetermined time comparison value, so that ultimately the presence of a door opening request can be determined according to step 78.

Insofar as the induced voltage has at least one fourth voltage pulse 59 depending on the second pressure actuation, wherein a fourth amplitude of the at least one fourth voltage pulse 59 is compared in a ninth comparison with the fourth voltage comparison value U4 and at least a part of a fourth temporal extent of the fourth voltage pulse 59 is compared in a tenth comparison with a fourth time comparison value, wherein the door opening request is additionally determined depending on the comparison result of the ninth and the tenth comparison. If the amplitude of the second voltage pulse 58 is greater than the voltage comparison value U4, it is determined that a door opening request is not present according to step 79. If the amplitude of the second voltage pulse 58 is smaller than the voltage comparison value U4, then the ninth comparison is positive. If the time period T4 is smaller than the predetermined fourth time comparison value, it is likewise determined that a door opening request is not present according to step 79. If the time period T4 is greater than the predetermined fourth time comparison value, the tenth comparison is positive or it determines the presence of a door opening request according to step 78. Insofar as the ninth and tenth comparison is positive or the presence of a door opening request has been detected in each case, the total value of T1 and T4 can also be formed and compared as to whether this is equal to or greater than a predetermined time comparison value or trigger of the door opening apparatus, so that ultimately the presence of a door opening request can be reliably determined.

Overall, it can be achieved that the door opening apparatus 11 can also be used as a sensor facility for detecting actuation by the user.

It is also not apparent from the figures that the door inner face 14 has a magnetizable material as a magnetizable support area 21 in a door area which is opposite the door opening apparatus 11 in the closed state. The magnetizable support area is formed in the present case by a ferromagnetic plate, the position and orientation of which can be in part adjusted. This allows the orientation of the ferromagnetic plate to be adjusted as required so that a most favorable effect of the door opening apparatus 11 can be achieved. For example, it may be provided that the ferromagnetic plate can be adjusted with regard to its position on the door inner face 14. This can also include a surface of the ferromagnetic plate deviating from a surface of the door inner face 14. In addition, swiveling, twisting or the like can also be provided, insofar as this is structurally expedient.

FIG. 4 shows a schematic perspective exploded view of a front section of the household refrigeration appliance 1 according to FIG. 1, in which the door opening apparatus 11 is to be arranged centrally above the access opening 25. It is apparent that a connecting unit 26 is provided for connecting the door opening apparatus 11 to the carcass 10 and the connecting unit in this case has a retaining plate. Furthermore, a retaining element 27 is provided, with which the door opening apparatus 11 can be fixed to the carcass 10 in the desired orientation, so that the longitudinal axis 18 is transverse to the door inner face 14 when the door 4 is in the closed state.

The connecting unit 26 and the retaining element 27 are used to establish a reliable connection of the door opening apparatus 11 to the carcass 10, as shown in the schematic representation according to FIG. 5, in which the door opening apparatus 11 is fixedly arranged on the carcass 10 of the household refrigeration appliance 1.

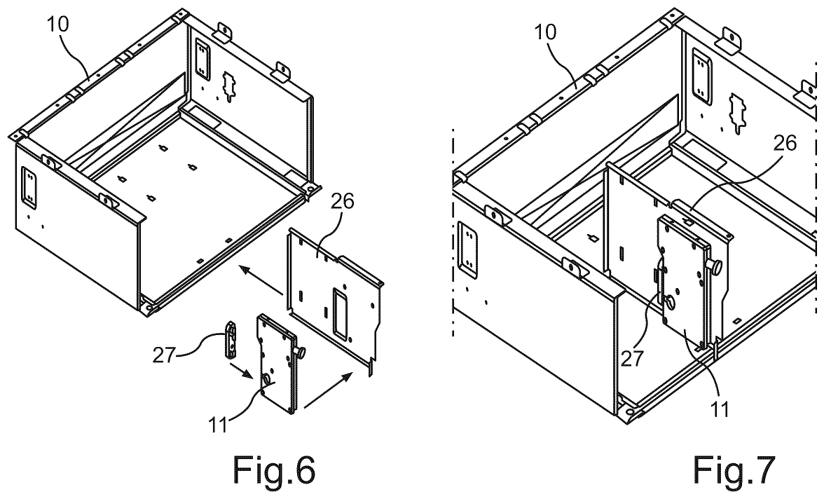

FIGS. 6 and 7 show representations such as FIGS. 4 and 5, wherein in this embodiment the door opening apparatus 11 is arranged approximately in the center below the access opening 25, namely in an area in which other components of the household refrigeration appliance 1 can also be arranged, for example relating to the cooling circuit. Reference is also made to the explanations relating in FIGS. 4 and 5.

The chosen embodiment of arranging the door opening apparatus 11 in the center in relation to the access opening 25 has the advantage that the door 4 ensures reliable functionality regardless of whether it stops on the left or right side of the body 10.

In the case of this embodiment, it is therefore possible to subsequently select or change the stop of the door 4 on the body 10.

The exemplary embodiments are used merely to explain the invention and are not intended to limit the invention.

The following is a summary list of reference numerals, and the corresponding structure used in the above description of the invention:
1 Household refrigeration appliance
2 Interior container
3 Interior space
4 Door
5 Door shelf
6 Shelf
7 Drawer
8 Control facility
10 Carcass
11 Door opening apparatus
12 Plunger
13 Rotating electric machine
14 Door inner face
15 Plunger head
16 Transmission
17 Support unit
18 Longitudinal axis
19 Sleeve
20 Housing
21 Magnetizable support area
22 Housing flange
23 Magnet
24 Helical spring
25 Access opening
26 Connecting unit
27 Retaining element
28 Stator
29 Rotor
30 Stator winding
31 Position sensor
32 circuit board
33 Inverter
34 Interface
35 Stop
36 Control unit
37 Circuit arrangement
38 Power supply unit
39 Voltage limiting unit
40 Measuring connections
41 Comparison unit
42 Amplifier unit
43 Filter unit
44 Operation amplifier
45 Operation amplifier
46 Operation amplifier
47 Comparison signal connection
48 Output connection
49 Time comparison comparator
50 Evaluation unit
51 Comparison signal connection
52 Door opening signal
53 to 59 Voltage pulse
61 Sensor facility
70 to 79 Step
C8, C10, C14, C21 Capacitor
D1, D2, D4, D5 Diode
R7 to R14, R16, R20, R23, R32 Resistor
80 to 83 Graph

1. A method for determining a door opening request based on a first pressure actuation of a user against an outer face of a door of a household appliance, wherein an opening of the door is effected by means of a plunger disposed so as to move in a direction of a longitudinal axis, wherein the longitudinal axis of the plunger is orientated in a transverse manner with respect to a door inner face when the door is in a closed state and the plunger has on a door side a first plunger end with a plunger head, wherein the plunger is driven by means of a rotating electric machine having a rotor disposed so as to be able to rotate with respect to a stator, for which purpose the rotor and the plunger are mechanically coupled in terms of drive technology by means of a transmission, wherein an electrical voltage is applied to a stator winding of the stator which is electrically coupled to a controller so as to cause the door to open at least during temporary support of the plunger head against the door inner face, wherein to mechanically support the plunger head against the door inner face at least when the door is in the closed state and at least outside of an application of the electrical voltage to the stator winding a force is applied to the plunger by means of a mechanical support unit and by means of a sensor facility which is electrically coupled to the stator winding where an induced voltage of the stator winding is detected outside of the application of the electrical voltage to the stator winding, wherein the induced voltage has at least one first voltage pulse depending on the first pressure actuation, the method comprises the steps of:
comparing a first amplitude of the at least one first voltage pulse in a first comparison with a first voltage comparison value;
comparing at least a part of a first temporal extent of the first voltage pulse in a second comparison with a first time comparison value; and
determining the door opening request depending on comparison results of the first comparison and the second comparison.

2. The method according to claim 1, which further comprises determining the first temporal extent of the at least one first voltage pulse in relation to the first voltage comparison value.

3. The method according to claim 1, which further comprises comparing the first amplitude with a second voltage comparison value in a third comparison, and the door opening request is additionally determined depending on a comparison result of the third comparison.

4. The method according to claim 3, wherein:
the induced voltage has at least one second voltage pulse depending on the first pressure actuation;
a second amplitude of the at least one second voltage pulse is compared in a fourth comparison with a third voltage comparison value;
a total value formed from at least the part of the first temporal extent of the first voltage pulse and at least a part of a second temporal extent of the second voltage pulse is compared in the second comparison with the first time comparison value; and
the door opening request is additionally determined depending on comparison results of the second comparison and the fourth comparison.

5. The method according to claim 1, wherein:
the induced voltage has at least one second voltage pulse depending on the first pressure actuation;
a second amplitude of the at least one second voltage pulse is compared in a fourth comparison with a third voltage comparison value;
an at least in part second temporal extent of the at least one second voltage pulse is compared in a fifth comparison with a second time comparison value; and
the door opening request is additionally determined depending on comparison results of the fourth comparison and the fifth comparison.

6. The method according to claim 4, which further comprises determining the second temporal extent of the at least one second voltage pulse in relation to the third voltage comparison value.

7. The method according to claim 4, which further comprises:
comparing the second amplitude in a sixth comparison with a fourth voltage comparison value; and
determining additionally the door opening request depending on a comparison result of the sixth comparison.

8. The method according to claim 7, which further comprises using at least one magnitude of at least one of the at least one first voltage pulse or the at least one second voltage pulse at least for the first, the third, the fourth or the sixth comparison.

9. The method according to claim 1, which further comprises:
determining the door opening request by a second pressure actuation of the user against the outer face of the door immediately following the first pressure actuation, wherein the induced voltage has at least one third voltage pulse depending on the second pressure actuation;
comparing a third amplitude of the at least one third voltage pulse in a seventh comparison with a second voltage comparison value;
comparing at least a part of a third temporal extent of the at least one third voltage pulse in an eighth comparison with a third time comparison value; and
additionally determining the door opening request depending on a comparison result of the seventh comparison and the eighth comparison.

10. The method according to claim 9, wherein:
the induced voltage has at least one fourth voltage pulse depending on the second pressure actuation;
a fourth amplitude of the at least one fourth voltage pulse is compared in a ninth comparison with a fourth voltage comparison value;
at least a part of a fourth temporal extent of the at least one fourth voltage pulse is compared in a tenth comparison with a fourth time comparison value; and
the door opening request is additionally determined depending on the comparison result of the ninth comparison and the tenth comparison.

11. The method according to claim 1, which further comprises determining the door opening request in a case of more than a single voltage pulse depending on a total value of a respective temporal extent of immediately successive individual pulses.

12. A sensor facility for determining a door opening request based on a pressure actuation of a user against an outer face of a door of a household appliance, wherein an opening of the door is effected by means of a plunger that is disposed so as to move in a direction of a longitudinal axis, wherein the longitudinal axis of the plunger is orientated in a transverse manner with respect to a door inner face when the door is in a closed state and the plunger has on a door side a first plunger end with a plunger head, wherein the plunger can be driven by means of a rotating electric machine which has a rotor that is disposed so as to be able to rotate with respect to a stator, for which purpose the rotor and the plunger are mechanically coupled in terms of drive technology by means of a transmission, wherein a predetermined electrical voltage is applied to a stator winding of the stator which is electrically coupled to a controller so as to cause the door to open at least during temporary support of the plunger head against the door inner face, wherein so as to mechanically support the plunger head against the door inner face at least when the door is in a closed state and at least outside of the application of the electrical voltage to the stator winding a force is applied to the plunger by means of a mechanical support unit and wherein the sensor facility is electrically coupled to the stator winding, the sensor facility being:
configured so as to detect an induced voltage of the stator winding at least outside of the application of the predetermined electrical voltage to the stator winding, wherein the induced voltage has at least one first voltage pulse depending on the pressure actuation, wherein the sensor facility is further configured to compare a first amplitude of the at least one first voltage pulse in a first comparison with a first voltage comparison value and to compare at least a part of a first temporal extent of the at least one first voltage pulse in a second comparison with a first time comparison value, and the door opening request is determined depending on comparison results of the first comparison and the second comparison.

13. The sensor facility according to claim 12, further comprising a circuit configuration which is electrically connected to the stator winding, so as to detect the induced voltage of the stator winding, wherein the circuit configuration has a first comparator and a second comparator for realizing the first comparison and the second comparison, wherein said first comparator is configured so as to compare the induced voltage with the first voltage comparison value, and wherein said second comparator is configured, depending on the first comparison result, so as to compare the at least in part said first temporal extent of the first voltage pulse in the second comparison with the first time comparison value, and to provide at least a result of the second comparison for further evaluation.

14. The sensor facility according to claim 13, wherein said circuit configuration rectifies the induced voltage.

15. A household appliance comprising:
a body defining an interior space with an access opening for accessing said interior space;
a door disposed on said body so as to be able to pivot about a pivot axis so as to close said access opening, said door having at least one door inner face;
a controller disposed on said body remote from the pivot axis so as to determine a pressure actuation to said door of the household appliance by a user;
an elastic seal, said door closes said access opening of said body of the household appliance to said interior space of the household appliance in that said at least one door inner face of said door is supported on said elastic seal disposed on said body and running around said access opening or said elastic seal is disposed on said door inner face running around a region of an edge of said access opening; and
said sensor facility according to claim 12.
